(19) United States
(12) Patent Application Publication
(10) Pub. No.: US 2004/0245010 A1
(43) Pub. Date: Dec. 9, 2004

(54) System and method for improving connectivity of multiple parallel connectors

(76) Inventors: Russell W. Banks, Simcoe (CA); Michael Byrne, Simcoe (CA)

Correspondence Address: Joseph Sofer, SOFER & HAROUN, L.L.P., Suite 910, 317 Madison Avenue, New York, NY, 10017, US

(21) Appl. No.: 10/453,159

(22) Filed: Jun. 3, 2003

(51) Int. Cl. H01B 7/00

(52) U.S. Cl. 174/120 R

(57) ABSTRACT

The present invention relates to a multiple parallel conductor for use in electrical devices. The conductor maintains a plurality of strands, each of which comprise a conductor and a solderable enamel layer, disposed on at least a portion of the conductor. An insulting varnish layer is also provided, disposed on the solderable enamel layer, so that when the plurality of metal strands are placed into a solder bath, the insulating varnish layer is removed from the conductor.

### FIELD OF THE INVENTION

The present invention relates to a multiple parallel conductor, in particular, to a continuously transposed cable, used for windings of electrical devices, such as transformers, with a plurality of strands, wherein each strand has a separate electrical insulation capable of easily being stripped for connectivity preparation.

### BACKGROUND

The majority of modern electrical devices and machines, specifically high power transformers, employ continuously transposed cables, known as CTC. A continuously transposed cable with a specified cross section has a number of mechanical and electrical advantages compared to a traditional cable of the same cross section and made of an individual conductor.

A continuously transposed cable is composed of a large number of strands, wherein each strand has a separate electrical insulation. The strands are connected in parallel at the ends. Furthermore, in the CT cables, also known as Roebel rods, the strands have an approximately rectangular cross section. Each strand includes an insulating varnish covering a conductor made of copper, aluminum or an alloy thereof. The strands, each having their own electrical insulation, are combined into a bundle so as to define an approximately rectangular cross section.

Typically, the magnetic wire insulation used on the strands in the multiple parallel conductors is an applied layer of polyvinyl coatings or polyvinyl acetyl resins, such as the commonly used Formvar®.

In addition to the insulation coating on the individual strands, an additional layer of epoxy, such as epoxy resin, may be bonded to the strands to improve cable lifespan in response to operation in very high power conditions. Typically, transformers that are continuously subjected to overload conditions experience a high level of mechanical force generated by electromagnetic effects. These forces interact to cause cable strand twisting, which results in a significant shorter lifespan for the cable. The epoxy bond covering the Formvar® layer causes the bundle to behave as one integrated unit so that the strands experience a lesser amount of twisting against each other.

When used in transformers, each strand of the multiple parallel conductor of a continuously transposed cable needs to be prepared for proper electrical connections. In order to make these connections, the insulation and epoxy needs to be stripped off of each of the individual strands in the cable before they are soldered to other electrical nodes. This process is extremely time consuming and requires a significant amount of human resources to be devoted to such a process.

Typically, a current stripping method employs mechanical removal by cutting off the insulation layer with a wire brush or a knife. Another approach is to remove the insulation by heat decomposition using a flame torch for example. Yet another method is to use chemicals such as alkali to remove the insulation strip. Finally, there has been attempts to remove the insulation layer by solder by decomposing it inside a molten solder bath.

None of the above methods have proven satisfactory. Therefore, there exists a need for manufacturing a cable, for use with transformers or other electrical devices, wherein the stripping and cleaning of the individual strands can be done quickly and effectively, reducing the amount of time needed to properly electrically connect the cables to other electrical nodes.

### SUMMARY OF THE INVENTION

It is therefore an object of the invention to provide an improved multiple parallel conductor for windings of electrical devices and machines that provides a simplified means for stripping and preparing the ends of the multiple parallel conductor cables for electrical connection to an electrical node.

This object is solved by the invention in that at least one layer of solderable material is disposed over the conductor in each strand before any insulation or epoxy is applied, so that when the end of the cable is placed into a solder bath, the solderable layer and all of the layers of insulation and epoxy on the strands are removed, quickly exposing the bare strands to be cleaned and inserted into the desired connection.

To this end a multiple parallel conductor for use in electrical devices comprises a plurality of strands, where each strand further comprises a conductor having a solderable enamel layer, disposed over at least a portion of the conductor in each strand. An insulting varnish layer is also provided, disposed on the solderable enamel layer. When the strand is placed into a molten solder bath, the insulating varnish layer is removed from the metal strand.

### BRIEF DESCRIPTION OF THE DRAWINGS

FIG. 1 is a perspective view of a first embodiment of a multiple parallel conductor made in accordance with the invention;

FIG. 2 is a front cross-sectional view of a second embodiment of the multiple parallel conductor of FIG. 1, having a varied support tape, in accordance with one embodiment of the present invention;

FIG. 3 is a longitudinal cross sectional view of a strand from the multiple parallel conductor of FIG. 1, in accordance with one embodiment of the present invention;

FIG. 4 is a front cross sectional view of the strand from the multiple parallel conductor of FIG. 3, in accordance with one embodiment of the present invention;

FIG. 5 is a flow chart illustrating the process of applying layers to the multiple parallel conductor from FIG. 3, in accordance with one embodiment of the present invention;

FIG. 6 is a diagram of a solderable enamel layer being applied to a multiple parallel conductor as shown in FIG. 3, in accordance with one embodiment of the present invention;

FIG. 7 is a flow chart illustrating the process of stripping the multiple parallel conductor from FIG. 1, in accordance with one embodiment of the present invention; and

FIG. 8 is an expanded side cross section view of the strand of the multiple parallel conductor of FIG. 3 with the ends of the strands having been stripped, in accordance with one embodiment of the present invention.

### DETAILED DESCRIPTION OF THE INVENTION

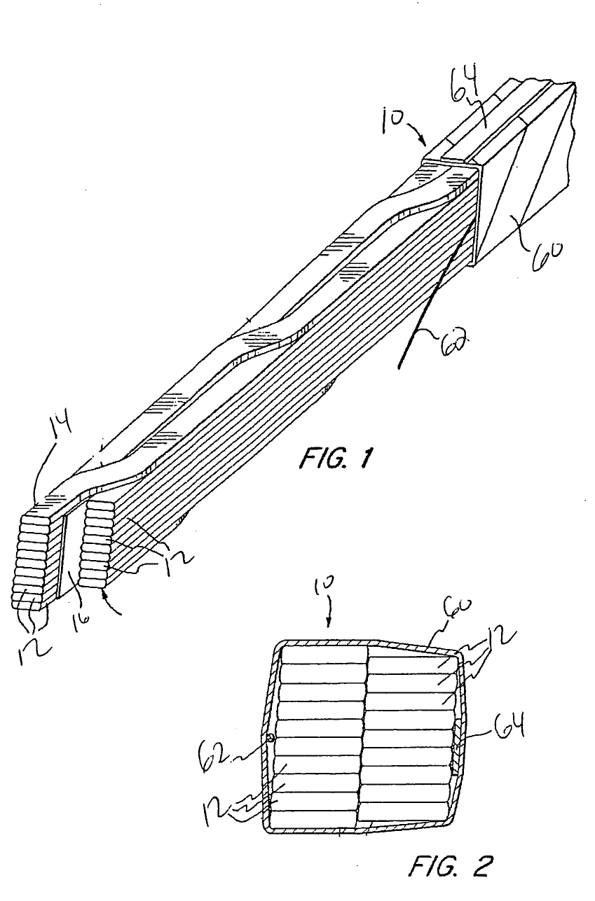

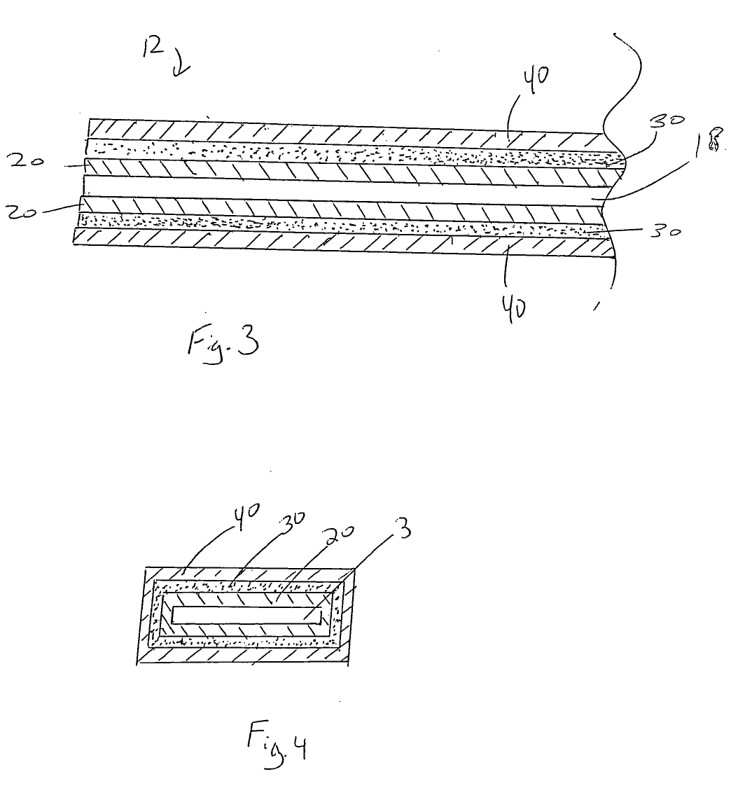

FIGS. 1 and 2 illustrate a multiple parallel conductor 10 for windings of electrical motors, including transformers, having a bundle of individual insulated transposed strands indicated as 12. Transposed strands 12 cross over one another as described in U.S. Pat. No. 5,962,945, the entirety of which is incorporated herein by reference. Strands 12, having a conductor material 18, are arranged, for example, in two juxtaposed stacks 14, with a paper tape 16 extending in the longitudinal direction between the two stacks 14, as is shown in FIG. 1.

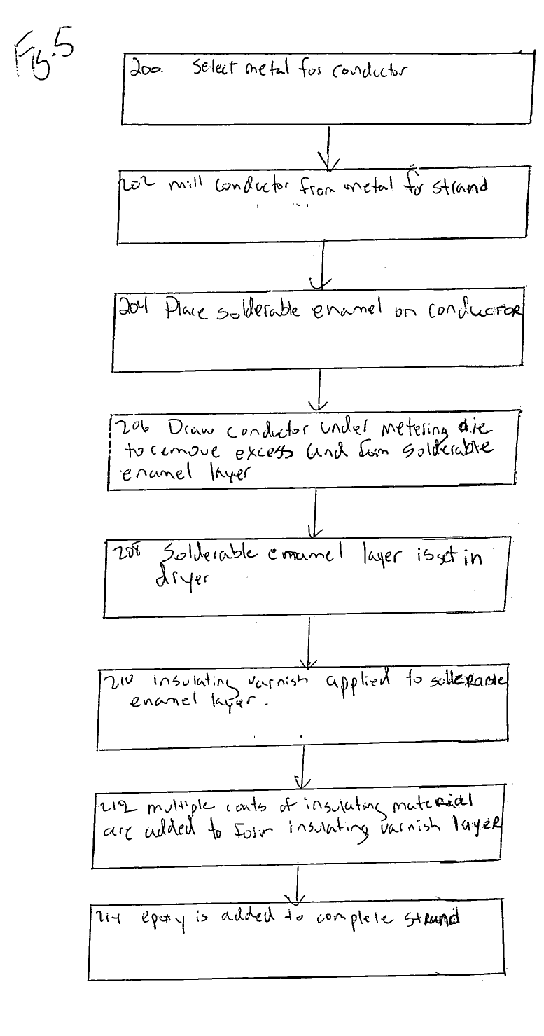

As illustrated in FIGS. 3 and 4, each one of strands 12 is coated with a solderable enamel layer 20, applied directly to conductor 18. Solderable enamel 20 is applied in coats evenly across the entire surface of conductor 18. Solderable enamel layer 20 can be applied to conductor 18 in any number of conventional methods such as with the use of a metering die. The thickness of solderable enamel layer 20 may vary depending on the type of insulation to be deposited on top of it. However, it is typically applied in a manner and a thickness that is aimed to prevent oxidation during or after the application process. For instance, oxidation may degrade the adhesion between conductor 18 and solderable enamel layer 20.

In accordance with one embodiment of the present invention, solderable enamel layer 20 is a applied in a single layer, curing to a final thickness of 0.0004 inches thick. This process can be done for each single strand 12 individually, or in a mass production process to multiple strands 12 simultaneously.

It should be noted that solderable enamel layer 20 is acting in the function of a protective layer between conductor 18 and an insulating varnish layer 30. Thus, any protective layer having similar properties for use with similar multiple parallel conductor 10 is also within the contemplation of the present invention. However, for the purposes of illustrating the salient features of the present invention, solderable enamel layer 20 is used.

Solderable enamel layer 20 may be applied in several coats or it can be applied in a single coating. The thickness of layer 20 may be varied to accommodate various types of metals used for conductor 18 of strand 12 as well as to accommodate various types of insulation to be applied thereto, provided that solderable enamel 20 is able to perform its functions as described in more detail below.

As illustrated in FIGS. 3 and 4, each strand 12 is provided with its own insulating varnish layer 30, to ensure adequate electrical insulation between the adjacent strands 12. For example, a typical insulating varnish layer 30 may be any polyvinyl coatings or polyvinyl acetyl resins such as Formvar® or any other similarly suited insulator that meets the insulating properties required by multiple parallel conductors 10. For the purposes of illustration of the salient features of the present invention, insulating varnish layer 30 will be assumed to be Formvar® coating, however this is in no way intended to limit the scope of the present invention. Any similar insulating material may be utilized in conjunction with strands 12 is within the contemplation of the present invention.

Insulating varnish layer 30 can be applied to strand 12 in any number of conventional methods. As illustrated in FIG. 3, insulating varnish layer 30 is applied on top of solderable enamel layer 20 after that layer is set or cured, such that insulating varnish layer 30 results in an insulation that preferably does not directly contact conductor 18 of strand 12.

The thickness of insulating varnish layer 30 may vary depending on the insulation requirements for strands 12, however it is typically applied in individual coats that, when cured, are 0.0004 inches thick. In a typical application for strand 12, somewhere between six and ten coats of insulation material or Formvar® are applied in order to form insulating varnish layer 30.

In one embodiment of the present invention, as illustrated in FIGS. 3 and 4, to improve the mechanical strength of the electrical insulation varnish layer 30, an additional coating of a partially cross-linked epoxy varnish 40 can also be applied over insulating varnish coating 30 of each strand 12. Epoxy layer 40 can be applied to strand 12 in any number of conventional methods. As illustrated in FIGS. 3 and 4, epoxy layer 40 is applied on top of insulation varnish layer 30 after the final coat of that layer is dry. This epoxy layer 40 results in a hardened epoxy or bond that rests on top of the insulation varnish layer 30 of strand 3.

The thickness of epoxy layer 40 may vary depending on the desired added strength to be added to strands 12, however it is typically applied in individual coats that, when dry, are 0.0004 inches thick. In a general application for strand 12, somewhere between 2 and 4 coats of epoxy are applied in order to form epoxy layer 40.

Along with insulating varnish layer 30 and solderable enamel layer 20, the thickness of epoxy layer 40, may be set to meet industry standards for multiple parallel conductors 10 such as NEPA (National Environmental Policy Act) and IEC (International Electrotechnical Commission).

It is noted that epoxy layer 40 is not required for proper operation of strands 12, but is included as an optional layer for illustration purposes only. Strands 12 with only solderable enamel layer 20 and insulation varnish layer 30 are also within the contemplation of the present invention.

As illustrated in FIGS. 1 and 2, after each strand 12 is properly coated with solderable enamel layer 20, insulating varnish layer 30 and epoxy layer 40, strands 12 are formed into multiple parallel conductors 10, such as continuously transposed cables for use in transformers. Additional elements may be added at this time to improve the quality of multiple parallel connectors 10.

For example, common wrapping 60, made of paper tapes, is placed over the bundle of electrically insulated strands 12 formed in this manner. A further element for improving multiple parallel conductors 10, illustrated in FIGS. 1 and 2, includes a rip cord 62 underneath wrapping 60, extending in the longitudinal direction along the entire length of the multiple parallel conductor 10, so that the wrapping 60 can be removed easily and cost-effectively during manufacture of the windings for electrical devices and machines, i.e. at the same time when the continuously transposed cables are wound.

Yet another element for improving multiple parallel conductors 10, illustrated in FIG. 1, includes a support tape 64. On the outside of the common wrapping 60 of strands 12, support tape 64 is disposed, that extends in the longitudinal direction of the multiple parallel conductor 10 and which is coated with an adhesive and affixed to the wrapping 60. Support tape 64 has the purpose to hold the individual elements of wrapping 60 together after the rip cord is torn, so that the wrapping 60 can be removed easily and completely without contamination from loose constituents of the wrapping.

In the embodiment illustrated in FIG. 2, support tape 64 extends parallel to the longitudinal direction of multiple parallel conductor 10, but is placed between one of the stacks of strands 12 and the inside of the wrapping 60 on that side of the multiple parallel conductor 10 which faces away from rip cord 62. A more thorough description of these and other improvements for multiple parallel conductor 10 can be found in U.S. Pat. No. 5,962,945, the entirety of which is incorporated herein by reference.

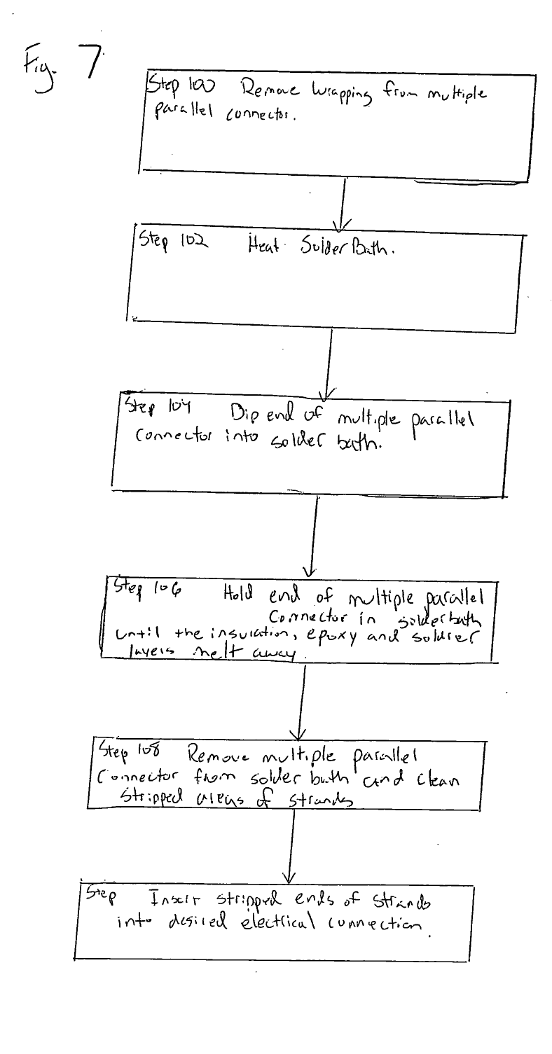

In one embodiment of the present invention as illustrated in FIG. 6, a cable assembly line 300 is provided. Assembly line 300 comprises a roller 302 containing bare conductor 18. Conductor 18 is spun off of roller 302 then through an in-line annealer 304 for applying the solderable enamel in an appropriate thickness by way of a metering die or other such manufacturing device. Positioned after in-line annealer 304, an RO (Reverse Osmosis purified) water bath 306, sponge wipes 308 and air dryer 310 are configured to remove excess solderable enamel and provide initial cooling for conductor 18 and solderable enamel layer 20.

An enamel oven 312 is positioned at the end of assembly line 300 so that conductor 18, having the just applied solderable enamel thereon, revolves on continuous rollers through oven 312 until the solderable enamel dries into solderable enamel layer 20. An application device 314 is positioned outside of enamel oven 312 so that after solderable enamel layer 20 is cured, insulating varnish and epoxy may be applied to form insulating varnish layer 30 and epoxy layer 40, to be dried and cured in the same enamel oven 312. The process for each step in the application process is described in more detail below.

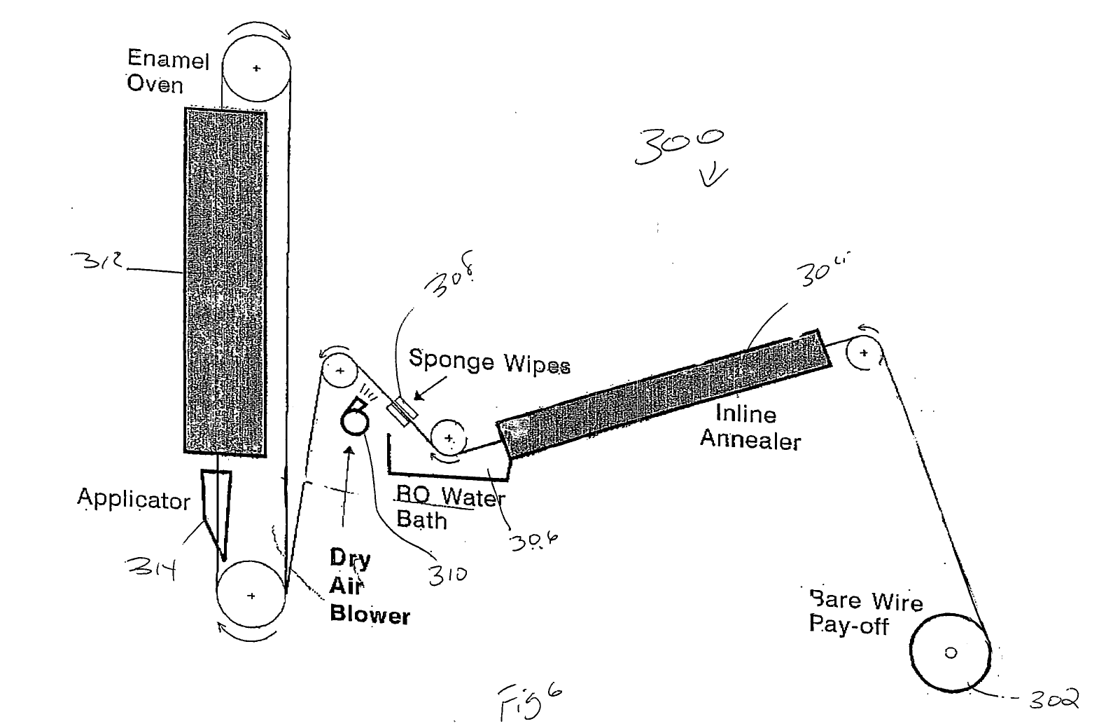

In one embodiment of the present invention as illustrated in flow chart of FIG. 5, strands 12 are generated for use in multiple parallel connector 12. At step 200, a conducting material is chosen to form conductor 18 of strand 12. After the material is selected, such as copper, at step 202, conductor 18 is drawn and milled into the proper thickness and shape to form multiple parallel conductor 10, such as flattened, substantially rectangular, strips for use in continuously transposed cables. Conductor 18 is then loaded onto rollers 302.

Next, at step 204, a solderable enamel is placed onto conductor 18 of strand 12. In order to prevent oxidation, the entire surface of conductor 18 is covered quickly. The solderable enamel used in solderable enamel layer 20 is applied in liquidized form. As illustrated in FIG. 6, at step 206, conductor 18 is drawn under a metering die within in-line annealer 304 so as to remove the excess solderable enamel, so as to form the uniformly thick solderable enamel layer 20 on conductor 18. As discussed previously, the metering die is set so as to form a solderable enamel layer 20 that, when cured, is substantially 0.0004 inches thick, however, this thickness may be adjusted as necessary.

Next at step 208, conductor 18, having solderable enamel layer 20 deposited thereon, is then moved into enamel oven 312 where solderable enamel layer 20 is allowed to set before applying the insulating varnish. The temperature of enamel oven 312 is set so as to provide adequate curing of layer 20.

After all of the coats of solderable enamel are cured onto conductor 18, forming the finished solderable enamel layer 20, at step 210, the insulating varnish is applied by application device 314 to the set solderable enamel layer 20 so as to form insulating varnish layer 30. The insulating varnish is applied to solderable enamel layer 20 at a temperature below that which would melt solderable enamel layer 20. At step 212, the insulating varnish is applied in a coat and dried in enamel oven 312 so that, when cured, it is approximately 0.0004 inches thick. As described above, insulating varnish layer 30 is applied to solderable enamel layer 20 and, as such, does not directly contact conductor 18. This makes the subsequent removal of insulating varnish layer 30, by way of solder bath, easier and more efficient

Next, at step 214, the process of applying coats of insulating material to strand 12 is repeated in stages until the desired thickness of insulating varnish layer 30 is complete. After insulating varnish layer 30 is complete, and the last coat of insulating material is dried at a temperature for delivering adequate curing, at step 216 the epoxy is added by application device 314 in similar process as outlined above. At step 218, the coating step is repeated, placing coats of epoxy onto strand 12 and dried in enamel oven 312 so that when cured, they are 0.0004 inch thick, until the final desired thickness of epoxy layer 40 is reached. Epoxy layer 40 is dried at a temperature sufficient to cause adequate curing.

Once solderable enamel layer 20, insulating varnish layer 30 and epoxy layer 40 are secured and dried onto conductor 18 of strand 12, the completed strands 12 are combined into multiple parallel connector 10 as illustrated in FIGS. 1 and 2.

It is noted that the thickness of the coats that form solderable enamel layer 20, insulating varnish layer 30 and epoxy layer 40, the duration and temperature for drying each coat as well as the final thickness of those layers may vary based on a number of factors including the ultimate use for strand 12 and the raw materials being used for the layers. However, any similar strands 12 created using similar methods, having a solderable enamel layer are within the contemplation of the present invention.

After the manufacture of multiple parallel conductor 10 is complete, it is ready for use in applications such as for use in high voltage transformers. It is noted that there are many uses for the multiple parallel conductor 10, as described above, however, for the purposes of illustration, it will be described herein in connection with its use in power transformers.

Before multiple parallel conductor 10 can be properly utilized, it must be prepared for insertion/connection with external electrical nodes. To do this, each strand 12 must be stripped (have the insulation removed) so that conductor 18 of strand 12 can directly contact the electrical nodes. In the prior art, each individual strand 12 needed to be stripped to an appropriate length, between 4″-8″ from the end, for every strand 12 in multiple parallel conductor 10. The present invention greatly reduces the labor required for such stripping procedure following the method outline below.

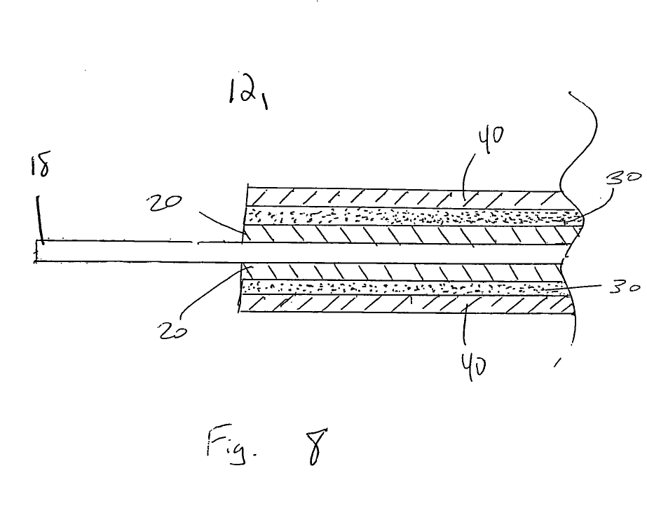

In one embodiment of the present invention, as illustrated in the flow chart of FIG. 7, at step 100, multiple parallel conductor 10, as illustrated in FIGS. 1 and 2 is prepared for insertion into an electrical node by way of removing of wrapping 60 using rip cord 62. Next, at step 102, a molten solder bath is prepared having enough liquidized solder to strip strands 12 to the appropriate length. The solder bath should be round enough to accommodate the entire the entire cross section of multiple parallel conductor 10 and deep enough to strip approximately 4-8 inches from strand 12.

The solder bath is heated to a degree sufficient to remove epoxy layer 40, insulating varnish layer 30, and solderable enamel layer 20. Preferably, the solder bath is heated to approximately 480 degrees centigrade. This is intended only as an example of one temperature that can be used, however, other temperatures, sufficient to remove all of the layers 20, 30 and 40 from strand 12 without being too hot so as to damage the metal also may be used as desired. The optimum temperature may vary based on the different materials used to form solderable enamel layer 20 and insulating varnish layer 30.

At step 104, the end of multiple parallel conductor 10 is dipped into the solder bath to a level such that the amount of insulating varnish layer 30 and epoxy layer 40 to be stripped from the end of strands 12 is submerged in the solder. It may be advantageous to slightly space or loosen strands 12 from one another so as to allow the molten solder in the solder bath to act equally on all of strand 12 of conductor 10.

Next at step 106, multiple parallel conductor 10 is held in the solder bath until the bare wire of strands 12 are cleared of any coatings. Exposure to these temperatures causes both epoxy layer 40 and insulating varnish layer 30, such as Formvar®, to melt away from solderable enamel layer 20 at a rapid rate. Then, as the strands 12 approaches the full temperature of the solder bath, solderable enamel layer 20 liquefies and becomes separated from the metal of strand 12 as well.

Alternatively, if tinning is desired, some of solderable enamel layer 20 may be left on the ends of strands 12 so as to strengthen the eventual soldered connection with the desired device. Typically each strand 12 requires about 20 seconds in the solder bath to remove epoxy layer 40, insulating varnish layer 30 and solderable enamel 20. However, when combined strands 12 from multiple parallel connector 10 are placed together in the solder bath, the time needed for proper stripping of all strands 12 is approximately 2 minutes. The duration for which strand 12 is held in the solder bath may very based on the melting properties and the thicknesses of layers 20, 30 and 40 as well as if tinning is desired.

After all of materials sought to be stripped are removed as illustrated in FIG. 8, at step 108, multiple parallel conductor 10 is removed from the solder bath and is cleaned. The cleaning can be done in any method capable of removing any residual solder of solderable enamel layer 20 from strands 12, including cleaning with an abrasive material or wire brush. If tinning of strands 12 is desired then solderable enamel layer 20 or a portion thereof may be left on strand 12, and cleaning by the above process is used to remove only excess insulating varnish layer 30 or epoxy layer 40 residue. The process is completed at step 110 when all of the excess materials are removed and strands 12 are clean and coupled to the desired electrical connection.

The embodiments described above remarkably achieves the objects of the invention. However, it will be appreciated that departures can be made by those skilled in the art without departing from the spirit and scope of the invention which is limited only by the following claims.

1. A multiple parallel conductor for use in electrical devices, said multiple parallel conductor comprising:
a plurality of strands, wherein each of said strands further comprises;
a conductor;
a solderable enamel layer, disposed on at least a portion of said conductor; and
an insulting varnish layer, disposed on said solderable enamel layer, such that when said plurality of metal strands are placed into a solder bath, said insulating varnish layer is removed from said conductor.

2. A multiple parallel conductor as claimed in claim 1, where in said multiple parallel conductor is a continuously transposed cable.

3. A multiple parallel conductor as claimed in claim 1, wherein said conductor is a substantially rectangular copper wire.

4. A multiple parallel conductor as claimed in claim 1, wherein said solderable enamel layer covers the entire said conductor.

5. A multiple parallel conductor as claimed in claim 4, wherein said solderable enamel layer is cured at a thickness of substantially 0.0004 inches.

6. A multiple parallel conductor as claimed in claim 1, wherein said insulating varnish layer is any one of a polyvinyl coatings and a polyvinyl acetyl resin.

7. A multiple parallel conductor as claimed in claim 1, wherein said insulating varnish layer is applied in a plurality of coats, each of said coats being substantially 0.0004 inches thick when cured.

8. A multiple parallel conductor as claimed in claim 1, further comprising an epoxy layer coated onto said insulating varnish layer configured to strengthen said strands against mechanical stress.

9. A multiple parallel conductor as claimed in claim 8, wherein said epoxy layer is formed from partially cross-linked epoxy varnish.

10. A multiple parallel conductor as claimed in claim 1, wherein said insulating varnish layer does not directly contact said conductor.

11. A multiple parallel conductor for use in electrical devices, said multiple parallel conductor comprising:
a plurality of strands, wherein each of said strands further comprises;
a conductor;
a protective layer, disposed on at least a portion of said conductor; and
an insulting varnish layer, disposed on said protective layer, such that when said plurality of metal strands are treated, said protective layer and said insulating varnish layer are removed from said conductor.

12-25. (cancelled without prejudice)
